(19) United States
(12) Patent Application Publication
(10) Pub. No.: US 2015/0109290 A1
(43) Pub. Date: Apr. 23, 2015

(54) DEVICE AND METHOD FOR REMOVING NOISE POINTS IN POINT CLOUDS

(71) Applicants: Fu Tai Hua Industry (Shenzhen) Co., Ltd., Shenzhen (CN); HON HAI PRECISION INDUSTRY CO., LTD., New Taipei (TW)

(72) Inventors: CHIH-KUANG CHANG, New Taipei (TW); XIN-YUAN WU, Shenzhen (CN); PENG XIE, Shenzhen (CN)

(21) Appl. No.: 14/519,308

(22) Filed: Oct. 21, 2014

(30) Foreign Application Priority Data
Oct. 22, 2013 (CN) 201310498681.4

(51) Int. Cl. G06T 17/20

(52) U.S. Cl. CPC G06T 17/20; G06T 2207/20024; G06T 2207/20182
USPC 345/420

(57) ABSTRACT

In a noise points removing method, a point cloud of an object and predetermined parameters relating to the point cloud are received. The point cloud is triangulated to construct a triangular mesh surface, then, the point cloud is divided into a plurality of subsets according to the triangular mesh surface and the predetermined parameters. Each of the subsets of selected one by one, point distances between each point in the selected subsets and all points in adjacent subsets of the selected subsets and subset distances between the selected subset and each of the adjacent subsets according to the point distances are computed. Noise points can be determined according to a number of points in the each of the subsets, the predetermined parameters, and the subset distances, and then be removed.

### CROSS-REFERENCE TO RELATED APPLICATIONS

This application claims priority to Chinese Patent Application No. 201310498681.4 filed on Oct. 22, 2013, the contents of which are incorporated by reference herein.

### FIELD

The present disclosure relates to point cloud processing technique, and particularly to a device and method for removing noise points in a point cloud.

### BACKGROUND

Three-dimensional (3D) scanners measure a large number of points on an object's surface, and output a point cloud as a data file. In a 3D coordinate system, points in the point cloud are usually defined by X, Y, and Z coordinates, and often are intended to represent the external surface of an object.

There may be many noise points mixed within the point cloud, usually, 0.1%-5%. The noise points would influence the processing speed and accuracy of the point cloud.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 illustrates a block diagram of an example embodiment of a computing device that includes a noise points removing system.

FIG. 2 illustrates a block diagram of an example embodiment of function modules of the noise points removing system in FIG. 1.

FIG. 3 is a flowchart of an example embodiment of a noise points removing method.

FIG. 4 is a flowchart of an example embodiment of a detailed description of block 306 in FIG. 3.

FIG. 5 shows an example of a triangular mesh surface.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The word “module,” as used hereinafter, refers to logic embodied in hardware or firmware, or to a collection of software instructions, written in a programming language, such as, for example, Java, C, or assembly. One or more software instructions in the modules may be embedded in firmware. It will be appreciated that modules may comprise connected logic units, such as gates and flip-flops, and may comprise programmable units, such as programmable gate arrays or processors. The modules described herein may be implemented as either software and/or hardware modules and may be stored in any type of non-transitory computer-readable storage medium or other computer storage device. The term “comprising,” when utilized, means “including, but not necessarily limited to”; it specifically indicates open-ended inclusion or membership in the so-described combination, group, series and the like.

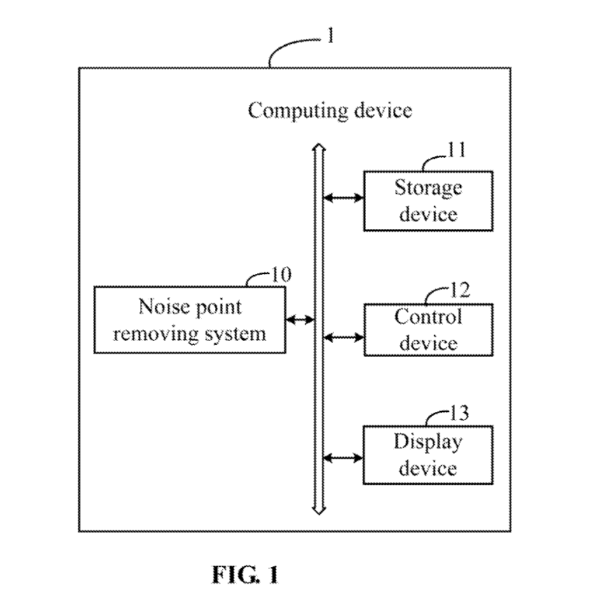

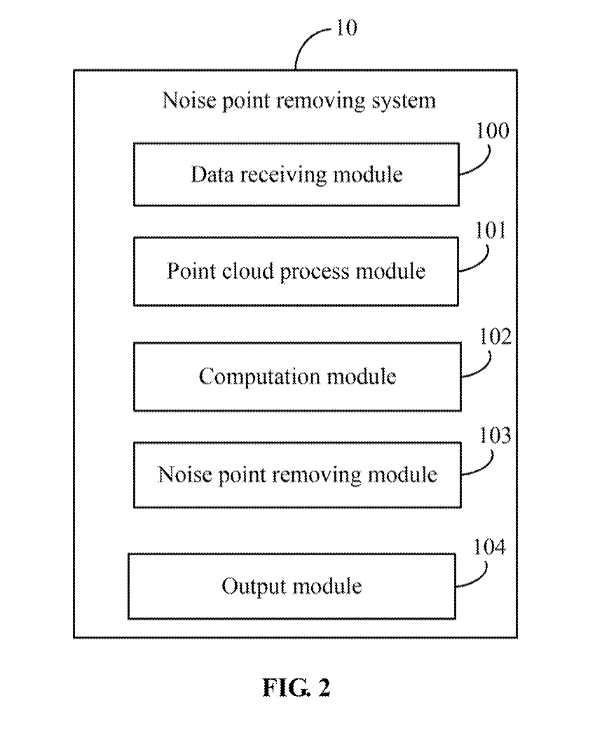

FIG. 1 illustrates a block diagram of an example embodiment of a computing device that includes a noise points removing system. In FIG. 1, a computing device 1 can be a server computer, a workstation computer, or any other suitable computing device. In the embodiment, the computing device 1 includes, but is not limited to, a noise points removing system 10, at least one storage device 11, and at least one control device 12, and a display device 13. The noise points removing system 10 includes various function modules (see FIG. 2 depicted below) including computerized instructions in the form of one or more computer-readable programs that can be stored in the at least one storage device 11, and can be implemented by the at least one control device 12 of the computing device 1. It may be understood that, FIG. 1 illustrates only one example of the computing device 1, and other examples can comprise more or fewer components than those shown in the embodiment, or have a different configuration of the various components.

In at least one embodiment, the at least one storage device 11 can include an internal storage system, such as a flash memory, a random access memory (RAM) for temporary storage of information, and/or a read-only memory (ROM) for permanent storage of information. The storage device 11 can also include an external storage system, such as an external hard disk, a storage card, or a data storage medium. The at least one control device 12 can include a central processing unit (CPU), a microprocessor, or other data processing chip that can perform various functions of the computing device 1. The display device 13 can be a screen of the computing device 1.

FIG. 2 illustrates a block diagram of an example embodiment of the function modules of the noise points removing system. The function modules can include a data receiving module 100, a point cloud process module 101, a computation module 102, a noise point removing module 103, and an output module 104.

The data receiving module 100 can receive a point cloud of an object and further receive predetermined parameters relating to the point cloud. The point cloud may be obtained from the storage device 11 of the computing device 1 or obtained from a 3D scanner. As mentioned above, the point cloud includes points on the object's surface, and can be defined by X, Y, and Z coordinates. In at least one embodiment, the predetermined parameters include a predetermined point distance and a predetermined point number.

The point cloud process module 101 can triangulate the point cloud and construct a triangular mesh surface, and divide the point cloud into a plurality of subsets according to the triangular mesh surface and the predetermined parameters.

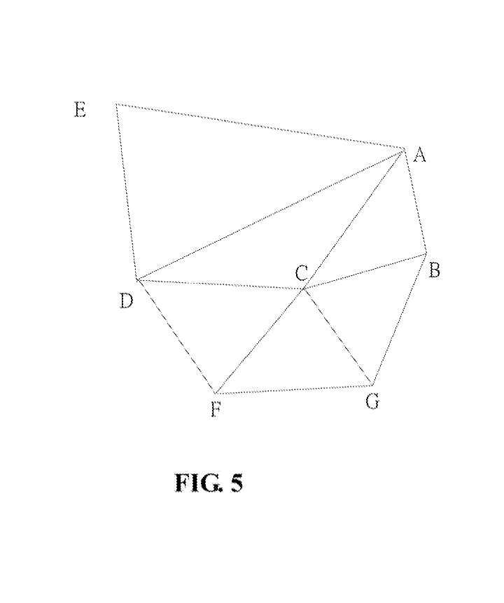

In at least one embodiment of dividing the point cloud into a plurality of subsets, the point cloud process module 101 randomly selects a point in the point cloud, and puts the selected point into a first subset, then computes a distance between the selected point and adjacent points of the selected point in the point cloud. The adjacent points include points that are in a same triangle with the selected point. Referring to FIG. 5, which shows an example of a triangular mesh surface, assuming that point A is the selected point, the adjacent points of the point A include points B, C, D and E. The point cloud process module 101 further filters the adjacent points and find one or more of the adjacent points whose distance to the selected point is less than the predetermine point distance, and puts the filtered adjacent points into the first subset. The point cloud process module 101 further selects a point from the first subset, and repeats computing a distance between the selected point and adjacent points of the selected point in the point cloud, finding one or more of the adjacent points, filtering the adjacent points, and putting the filtered adjacent points into the first subset. After the first subset is finished, the point cloud process module 101 repeats all of the above mentioned operations to generate a second subset, a third subset, until a nth subset.

The computation module 102 can select each of the subsets, compute point distances between each point in the selected subsets and all points in adjacent subsets of the selected subsets, and further compute subset distances between the selected subset and each of the adjacent subsets according to the point distances. It may be understood that, the adjacent subsets are subsets including points which are in same triangles with points in the selected subset. Referring to FIG. 5, assuming that points A and B are in a subset 1, points C and G are in a subset 2, points D and F are in a subset 3, and point E is in a subset 4, the subset 2 and the subset 4 are determined to be the adjacent subsets of the subset 1, the subset 1 and the subset 3 are determined to be the adjacent subsets of the subset 2, the subset 2 and the subset 4 are determined to be the adjacent subsets of the subset 3, and the subset 1 and the subset 3 are determined to be the adjacent subsets of the subset 4.

Depending on the example, the computation module 102 may select the subset 1, the subset 2, the subset 3, and the subset 4 one by one. When the subset 1 is selected, the computation module 102 computes point distances between each points in the subset 1 and all points in the subset 2 and the subset 4. When the subset 2 is selected, the computation module 102 computes point distances between each point in the subset 2 and all points in the subset 1 and subset 3. When the subset 3 is selected, the computation module 102 computes point distances between each points in the subset 3 and all points in the subset 2 and subset 4. When the subset 4 is selected, the computation module 102 computes point distances between each point in the subset 4 and all points in subset 1 and the subset 3.

In at least one embodiment, the subset distance between the selected subset and each of the adjacent subsets can be the minimum point distance.

The noise point removing module 103 can determine noise points in each of the subsets according to a number of points in each of the subsets, the predetermined parameters, and the subset distances, and generate a filter point cloud by removing the noise points from the point cloud. In at least one embodiment, when the number of points in a subset is less than the predetermined point number, all points in the subset are considered as the noise points. In another embodiment, when the number of points in a subset is less than the predetermined point number and the subset distance between the subset and at least one of the adjacent subsets is greater than a predetermined subset distance, all points in the subset are considered as the noise points. In at least one embodiment, the predetermined subset distance may be twice of the predetermined point distance.

The output module 104 can output the filtered point cloud using the display device 13 of the computing device 1.

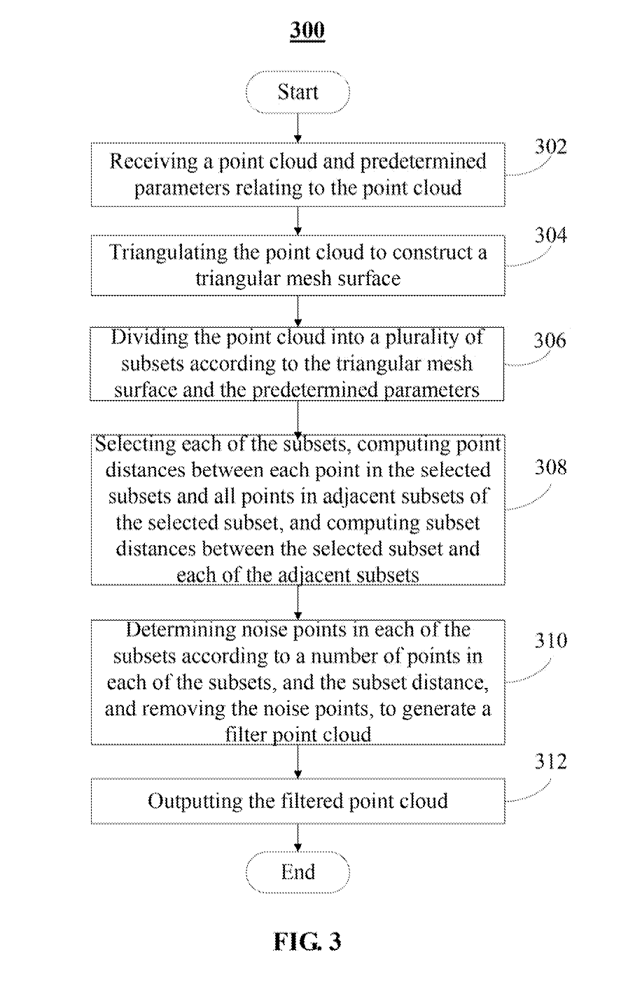

FIG. 3 is a flowchart of an example embodiment of a noise points removing method. Referring to FIG. 3, a flowchart is presented in accordance with an example embodiment illustrated. The example method 300 is provided by way of example, as there are a variety of ways to carry out the method. The method 300 described below can be carried out using the configurations illustrated in FIGS. 1 and 2, for example, and various elements of these figures are referenced in explaining example method 300. Each block shown in FIG. 3 represents one or more processes, methods or subroutines, carried out in the exemplary method 300. Furthermore, the illustrated order of blocks is by example only and the order of the blocks can change according to the present disclosure. Additional blocks may be added or fewer blocks may be utilized, without departing from this disclosure. The exemplary method 300 can begin at block 302.

At block 302, a data receiving module receives a point cloud of an object and further receives predetermined parameters relating to the point cloud. The point cloud may be obtained from a storage device or obtained from a 3D scanner. As mentioned above, the point cloud includes points on the object's surface, and can be defined by X, Y, and Z coordinates. In at least one embodiment, the predetermined parameters include a predetermined point distance and a predetermined point number.

At block 304, a point cloud process module triangulates the points in the point cloud, and constructs a triangular mesh surface.

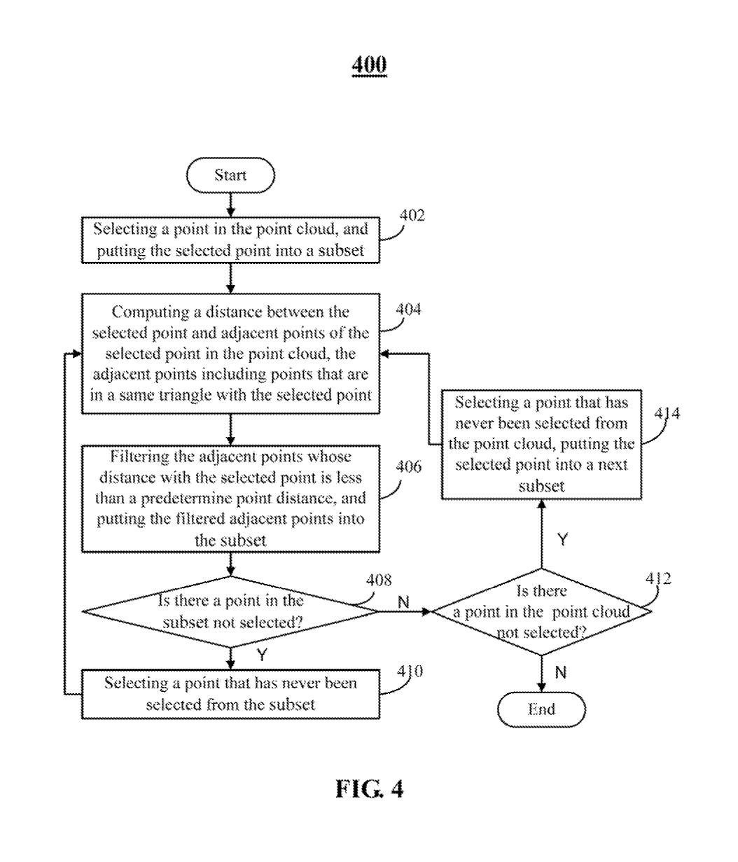

At block 306, a point cloud process module divides the point cloud into a plurality of subsets according to the triangular mesh surface and the predetermined parameters. A detailed description of block 306 is shown in FIG. 4.

At block 308, a computation module selects each of the subsets, computes point distances between each point in the selected subsets and all points in adjacent subsets of the selected subsets, and further computes subset distances between the selected subset and each of the adjacent subsets according to the point distances.

It may be understood that, the adjacent subsets are the subsets including points which are in the same triangles with points in the selected subset. Referring to FIG. 5, which shows an example of a triangular mesh surface, assuming points A and B are in a subset 1, points C and G are in a subset 2, points D and F are in a subset 3, and point E is in a subset 4, the subset 2 and the subset 4 are determined to be the adjacent subsets of the subset 1, the subset 1 and the subset 3 are determined to be the adjacent subsets of the subset 2, the subset 2 and the subset 4 are determined to be the adjacent subsets of the subset 3, and the subset 1 and the subset 3 are determined to be the adjacent subsets of the subset 4.

Depending on the example relating to FIG. 5, the computation module 102 may select the subset 1, the subset 2, the subset 3, and the subset 4 one by one. When the subset 1 is selected, the computation module 102 computes point distances between each points in the subset 1 and all points in the subset 2 and the subset 4. When the subset 2 is selected, the computation module 102 computes point distances between each point in the subset 2 and all points in the subset 1 and subset 3. When the subset 3 is selected, the computation module 102 computes point distances between each points in the subset 3 and all points in the subset 2 and subset 4. When the subset 4 is selected, the computation module 102 computes point distances between each point in the subset 4 and all points in subset 1 and the subset 3.

In at least one embodiment, the subset distance between the selected subset and one of the adjacent subsets can be the minimum point distance.

At block 310, a noise point removing module determines noise points in each of the subsets according to a number of points in the each of the subsets, the predetermined parameters, and the subset distances, and generates a filter point cloud by removing the noise points from the point cloud. In at least one embodiment, when the number of points in a subset is less than the predetermined point number, all the points in the subset are considered as the noise points. In another embodiment, when the number of points in a subset is less than the predetermined point number, and furthermore, the subset distance between the subset and at least one of the adjacent subsets is greater than a predetermined subset distance, all the points in the subset are considered as the noise points. In at least one embodiment, the predetermined subset distance may be twice of the predetermined point distance.

At block 312, an output module outputs the filtered point cloud using a display device.

FIG. 4 is a flowchart of an example embodiment of a detailed description of the block 306 in FIG. 3. Referring to FIG. 4, a flowchart is presented in accordance with an example embodiment illustrated. The example method 400 is provided by way of example, as there are a variety of ways to carry out the method. The method 400 described below can be carried out using the configurations illustrated in FIGS. 1 and 2, for example, and various elements of these figures are referenced in explaining example method 400. Each block shown in FIG. 4 represents one or more processes, methods or subroutines, carried out in the exemplary method 400. Furthermore, the illustrated order of blocks is by example only and the order of the blocks can change according to the present disclosure. Additional blocks may be added or fewer blocks may be utilized, without departing from this disclosure. The exemplary method 400 can begin at block 402.

At block 402, the point cloud process module selects a point in the point cloud, and puts the selected point into a subset. Initially, the selection of the point may be random.

At block 404, the point cloud process module computes a distance between the selected point and adjacent points of the selected point in the point cloud. In at least one embodiment, the adjacent points can include points that are in a same triangle with the selected point. Referring to FIG. 5, assuming that point A is the selected point, then, the adjacent points of the point A include points B, C, D and E.

At block 406, the point cloud process module filters the adjacent points to find one or more of the adjacent points whose distance to the selected point is less than a predetermine point distance, and puts the filtered adjacent points into the subset.

At block 408, the point cloud process module determines if there is a point in the subset not being selected by the point cloud process module. For example, at block 402, the point cloud process module selects the point A, and puts this point A into the subset, and at block 406, the point cloud process module puts the filtered adjacent points B and C into the subset, then the points B and C are not selected. When there is a point in the subset not being selected, block 410 is implemented, and when there is no point in the subset not being selected, block 412 is implemented.

At block 410, the point cloud process module selects a point that has never been selected from the subset, then, blocks 404, 406, and 408 are implemented repeatedly.

At block 412, the point cloud process module determines if there is a point in the point cloud not being selected, that is, if there is a point in the point cloud not being inputted to any subset. When there is a point in the point cloud not being selected, block 414 is implemented, and when there is no point in the point cloud not being selected, the procedure ends.

At block 414, the point cloud process module selects a point that has never been selected from the point cloud, and puts the selected point into a next subset. Then, blocks 404, 406, and 408, 410, and 412 are implemented repeatedly.

The embodiments shown and described above are only examples. Many details are often found in the art. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure, up to and including, the full extent established by the broad general meaning of the terms used in the claims. It will therefore be appreciated that the embodiments described above may be modified within the scope of the claims.

What is claimed is:

1. A method of removing noise points, the method executable by at least one processor of a computing device, and comprising:
receiving a point cloud of an object and predetermined parameters relating to the point cloud;
triangulating points in the point cloud and constructing a triangular mesh surface;
dividing the point cloud into a plurality of subsets according to the triangular mesh surface and the predetermined parameters;
selecting one of the plurality of subsets, computing point distances between each point in the selected subset and all points in adjacent subsets of the selected subset, and computing subset distances between the selected subset and each of the adjacent subsets according to the point distances;
determining noise points in the plurality of subsets according to a number of points in the each of the plurality of subsets, the predetermined parameters, and the subset distances, and generating a filter point cloud by removing the noise points from the point cloud; and
rendering a visual representation of the filtered point cloud on a display device.

2. The method according to claim 1, wherein the adjacent subsets are subsets that comprise one or more points which are in the same triangles with points in the selected subset.

3. The method according to claim 1, wherein the subset distance is the minimum point distance between the selected subset and each of the adjacent subsets.

4. The method according to claim 1, wherein the predetermined parameters comprises a predetermined point distance and a predetermined point number.

5. The method according to claim 4, wherein the point cloud is divided into a plurality of subsets by:
selecting a point in the point cloud, and putting the selected point into a subset;
computing a distance between the selected point and adjacent points of the selected point in the point cloud, the adjacent points comprising points that are in a same triangle with the selected point;
determining one or more of the adjacent points whose distance to the selected point is less than the predetermine point distance, filtering the adjacent points, and putting the filtered adjacent points into the subset; and
returning to selecting another point in the point cloud until all points in the subset have been selected.

6. The method according to claim 4, wherein all points in the subset are considered as the noise points when the number of points in the subset is less than the predetermined point number.

7. The method according to claim 4, wherein all points in the subset are considered as the noise points when the number of points in the subset is less than the predetermined point number, and the subset distance between the subset and at least one of the adjacent subsets is greater than a predetermined subset distance.

8. A computing device, comprising:
a display device;
a control device; and
a storage device storing one or more programs which, when executed by the control device, causes the control device to:
receive a point cloud of an object and predetermined parameters relating to the point cloud;
triangulate points in the point cloud and constructing a triangular mesh surface;
divide the point cloud into a plurality of subsets according to the triangular mesh surface and the predetermined parameters;
select one of the plurality of subsets, compute point distances between each point in the selected subset and all points in adjacent subsets of the selected subset, and compute subset distances between the selected subset and each of the adjacent subsets according to the point distances;
determine noise points in the plurality of subsets according to a number of points in the each of the plurality of subsets, the predetermined parameters, and the subset distances, and generate a filter point cloud by removing the noise points from the point cloud; and
rendering a visual representation of the filtered point cloud on the display device.

9. The computing device according to claim 8, wherein the adjacent subsets are subsets that comprise one or more points which are in the same triangles with points in the selected subset.

10. The computing device according to claim 8, wherein the subset distance is the minimum point distance between the selected subset and each of the adjacent subsets.

11. The computing device according to claim 8, wherein the predetermined parameters comprises a predetermined point distance and a predetermined point number.

12. The computing device according to claim 11, the one or more programs when executed by the control device, further causes the control device to:
select a point in the point cloud, and putting the selected point into a subset;
compute a distance between the selected point and adjacent points of the selected point in the point cloud, the adjacent points comprising points that are in a same triangle with the selected point;
determine one or more of the adjacent points whose distance to the selected point is less than the predetermine point distance, filter the adjacent points, and put the filtered adjacent points into the subset; and
return to selecting another point in the point cloud until all points in the subset have been selected.

13. The computing device according to claim 11, wherein all points in the subset are considered as the noise points when the number of points in the subset is less than the predetermined point number.

14. The computing device according to claim 11, wherein all points in the subset are considered as the noise points when the number of points in the subset is less than the predetermined point number, and the subset distance between the subset and at least one of the adjacent subsets is greater than a predetermined subset distance.

15. A non-transitory storage medium having stored thereon instructions that, when executed by a processor of a computing device, causes the processor to perform a method of removing noise points, wherein the method comprises:
receiving a point cloud of an object and predetermined parameters relating to the point cloud;
triangulating points in the point cloud and constructing a triangular mesh surface;
dividing the point cloud into a plurality of subsets according to the triangular mesh surface and the predetermined parameters;
selecting one of the plurality of subsets, computing point distances between each point in the selected subset and all points in adjacent subsets of the selected subset, and computing subset distances between the selected subset and each of the adjacent subsets according to the point distances;
determining noise points in the plurality of subsets according to a number of points in the each of the plurality of subsets, the predetermined parameters, and the subset distances, and generating a filter point cloud by removing the noise points from the point cloud; and
rendering a visual representation of the filtered point cloud on a display device.

16. The non-transitory storage medium according to claim 15, wherein the predetermined parameters comprises a predetermined point distance and a predetermined point number.

17. The non-transitory storage medium according to claim 15, wherein all points in the subset are considered as the noise points when the number of points in the subset is less than the predetermined point number.

18. The non-transitory storage medium according to claim 17, wherein the point cloud is divided into a plurality of subsets by:
selecting a point in the point cloud, and putting the selected point into a subset;
computing a distance between the selected point and adjacent points of the selected point in the point cloud, the adjacent points comprising points that are in a same triangle with the selected point;
determining one or more of the adjacent points whose distance to the selected point is less than the predetermine point distance, filtering the adjacent points, and putting the filtered adjacent points into the subset; and
returning to selecting another point in the point cloud until all points in the subset have been selected.

19. The non-transitory storage medium according to claim 17, wherein all points in the subset are considered as the noise points when the number of points in the subset is less than the predetermined point number.

20. The method according to claim 17, wherein all points in the subset are considered as the noise points when the number of points in the subset is less than the predetermined point number, and the subset distance between the subset and at least one of the adjacent subsets is greater than a predetermined subset distance.
